(19) United States
(12) Patent Application Publication
(10) Pub. No.: US 2018/0186322 A1
(43) Pub. Date: Jul. 5, 2018

(54) VEHICLE CENTER CONSOLE MOUNTED CAMERA SYSTEM

(71) Applicant: Dura Operating, LLC, Auburn Hills, MI (US)

(72) Inventor: Cumhur Unveren, Commerce Twp., MI (US)

(21) Appl. No.: 15/398,036

(22) Filed: Jan. 4, 2017

(51) Int. Cl. B60R 21/015; H04N 5/225; H04N 5/232; G06K 9/00

(52) U.S. Cl. CPC B60R 21/01538; H04N 5/2252; G06K 9/00845; G06K 9/00255; H04N 5/23238

(57) ABSTRACT

A vehicle console camera system includes a console positioned in a dashboard of a motor vehicle. A camera unit is mounted to an upper surface of the console. The camera unit includes a camera having a camera lens facing rearward. A viewing window of the camera captures images of each of an operator and a front seat passenger of the motor vehicle. A range of the viewing window permits facial features and recognition of the operator and the front seat passenger to be identified by software provided within a central processing unit.

### INTRODUCTION

The present disclosure relates to an automobile console and passenger identification and communication equipment provided with the console.

### BACKGROUND

Common automobile center consoles provide features such as a stereo, an emergency signal switch, and a screen providing features such as GPS navigation information, heating and cooling system controls, tire pressure warning systems, and contact information such as receipt of telephone calls and emails during vehicle operation. Sensor systems are known which utilize two or more sensors to triangulate features of the vehicle operator or a passenger such that a warning can be initiated if the operator begins to get drowsy or falls asleep. Such sensor systems require multiple sensors in order to locate and triangulate each passenger of the vehicle, and therefore do not limit the sensor locations to just the center console, or to the dashboard of the vehicle.

Thus, while current automobile center console systems achieve their intended purpose, there is a need for a new and improved system for observation of passengers and for detection of passenger gestures.

### SUMMARY

According to several aspects, a vehicle console camera system includes a console positioned in a motor vehicle passenger compartment. A camera is mounted to an upper surface of the console, the camera having a camera lens facing rearward. A viewing window of the camera captures at least an upper torso and a head of an operator of the motor vehicle.

In another aspect of the present disclosure, the camera is incorporated into a camera unit, and wherein the console includes an upper portion which directly supports the camera unit.

In another aspect of the present disclosure, the camera unit includes a camera housing incorporating the camera positioned above the upper portion.

In another aspect of the present disclosure, the camera housing includes a motor vehicle front facing portion which is partially received and retained within a cavity of the upper portion of the console.

In another aspect of the present disclosure, a camera body enclosure is integrally connected to the camera housing having a portion of the camera body enclosure received within the upper portion with a predefined length of the camera body enclosure extending outward from and above the upper portion.

In another aspect of the present disclosure, a horizontal central axis of the camera lens is positioned at an elevation above the upper surface of the vehicle console, and wherein the camera lens is elevated above the upper surface of the upper portion.

In another aspect of the present disclosure, the console is substantially centrally positioned in a dashboard of the motor vehicle.

In another aspect of the present disclosure, the camera is positioned on a longitudinal central axis of the motor vehicle.

In another aspect of the present disclosure, the viewing window further captures at least a front passenger of the motor vehicle.

In another aspect of the present disclosure, the viewing window further captures at least one rear passenger of the motor vehicle.

In another aspect of the present disclosure, an electrical output of the camera is communicated to a central processing unit.

In another aspect of the present disclosure, an output of the camera defines a digital signal.

In another aspect of the present disclosure, the camera is located at a minimum height above a floor of the motor vehicle permitting the viewing window to further include a front passenger and at least one rear seat passenger of the motor vehicle.

In another aspect of the present disclosure, a range of the viewing window permits facial features and recognition of each of multiple motor vehicle passengers, as well as reception of gestures made by any of the motor vehicle passengers to be identified by software provided within a central processing unit.

According to several aspects, a vehicle console camera system includes a console positioned in a dashboard of a motor vehicle. A camera unit is mounted to an upper surface of the console, the camera unit including a camera having a camera lens facing rearward. A viewing window of the camera captures images of each of an operator and a front seat passenger of the motor vehicle. A range of the viewing window permits facial features and recognition of the operator and the front seat passenger to be identified by software provided within a central processing unit.

In another aspect of the present disclosure, the camera unit is positioned on a longitudinal central axis of the motor vehicle and at a minimum height above a floor of the motor vehicle predetermined to maximize the range of the viewing window.

In another aspect of the present disclosure, the range of the viewing window further permits reception of gestures made by the operator and the front seat passenger.

In another aspect of the present disclosure, the camera lens defines a wide angle lens having an approximate 180 degree viewing area.

In another aspect of the present disclosure, a camera body of the camera is partially received within a camera body enclosure of the camera unit. The camera body enclosure is positioned within an aperture of the upper portion of the console. The aperture of the upper portion provides access from below the upper portion to access a signal connector of the camera.

According to several aspects, a vehicle console camera system includes a console positioned in a dashboard of a motor vehicle passenger compartment. A camera unit is mounted to an upper portion of the console and is positioned on a longitudinal central axis of the motor vehicle. The camera unit includes: a single digital camera having a wide angle camera lens facing rearward into the passenger compartment; a camera housing having a motor vehicle front facing portion partially received and retained within a cavity of the upper portion of the console; and a camera body enclosure integrally connected to the camera housing. The camera is positioned within the camera body enclosure having the camera lens extending through a lens cavity created in a rear facing wall of the camera housing. A viewing window of the camera captures images of each of an operator and a front seat passenger of the motor vehicle. A range of the viewing window permits facial features and recognition of the operator and the front seat passenger, as well as reception of gestures made by the operator and the front seat passenger to be identified by software provided within a central processing unit.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of a vehicle console camera system according to an exemplary embodiment;

FIG. 2 is a rear right perspective view of the vehicle of FIG. 1;

FIG. 3 is a rear right perspective view of a center console according to an exemplary embodiment;

FIG. 4 is a top right perspective view of a camera unit according to an exemplary embodiment; and

FIG. 5 is a front elevational view of the camera unit of FIG. 4; and

FIG. 6 is an exploded top perspective view of the camera unit of FIG. 4.

### DETAILED DESCRIPTION

The following description is merely exemplary in nature and is not intended to limit the present disclosure, application, or uses.

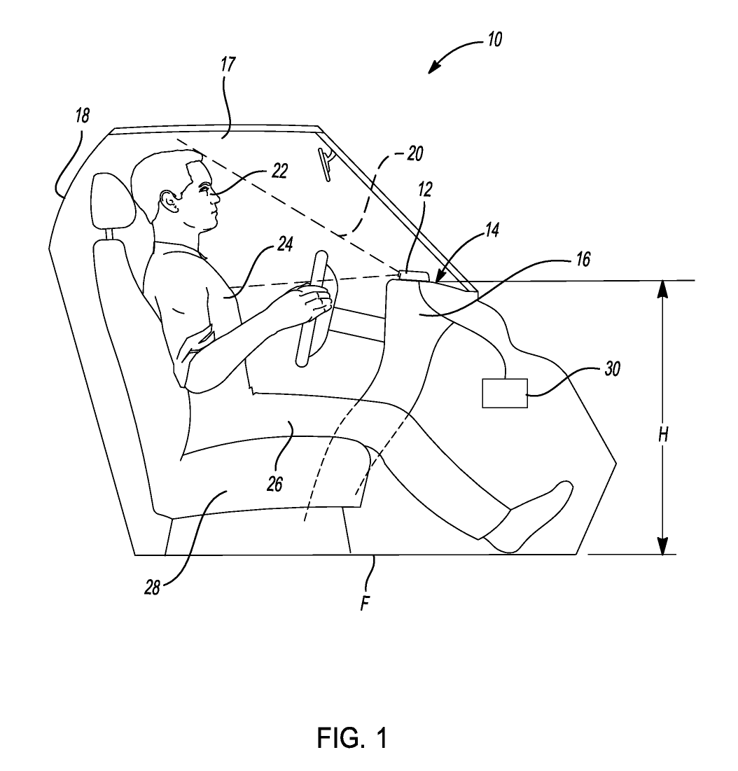

Referring to FIG. 1, a vehicle console camera system 10 includes a camera unit 12 positioned above and in direct contact with an upper surface 14 of a vehicle center console 16. The console 16 is positioned in a passenger compartment 17 of a motor vehicle 18. The camera unit 12 receives images in an image viewing window 20 which captures the images of at least a face and head 22 and at least a portion of an upper torso 24 of a vehicle operator 26 who defines one of multiple passengers of the motor vehicle 18. The viewing window 20 of the camera unit 12 captures the features of the operator 26 when the operator 26 is seated in a vehicle seat 28. An electrical output of the camera unit 12 such as a digital signal is communicated to a central processing unit 30, which according to several aspects can be positioned within the console 16, within a dashboard proximate to the console 16, or positioned elsewhere in the motor vehicle 18 such as for example in a trunk area.

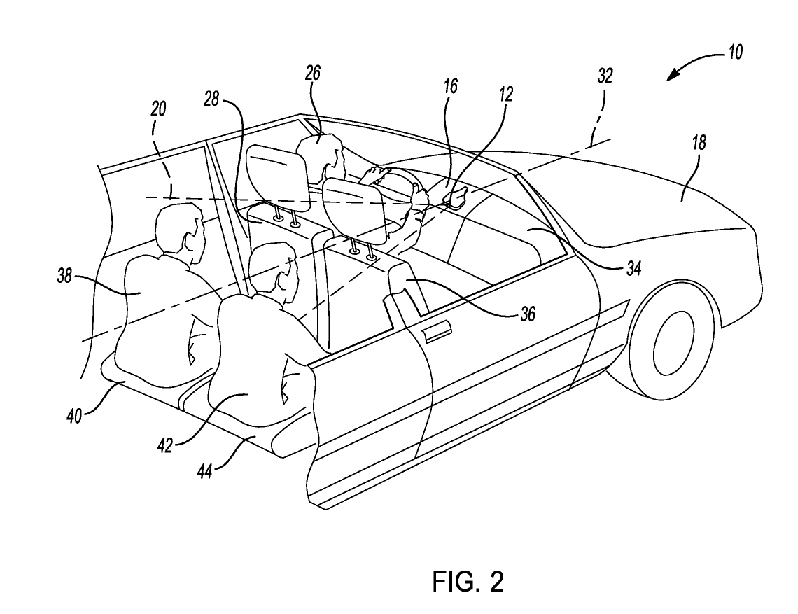

The camera unit 12 is located at a minimum height “H” above a floor “F” of the motor vehicle 18 permitting the viewing window 20 to also include a front passenger and at least one rear seat passenger of the motor vehicle 18, which are shown and described in greater detail in reference to FIG. 2. The minimum height “H” is predetermined to maximize the range of the viewing window 20 based on the geometry and spacing of the vehicle seats and interior components from the camera unit 12, which varies between different vehicle designs.

Referring to FIG. 2 and again to FIG. 1, the vehicle console camera system 10 positions the camera unit 12 on a longitudinal center axis 32 of the motor vehicle 18, which therefore substantially bisects a dashboard 34. The longitudinal center axis 32 positioning combined with the minimum height “H” of the camera unit 12 described in reference to FIG. 1 together permit the viewing window 20 to also include portions of at least a front passenger (not shown for clarity) seated in a front passenger seat 36, at least the upper torso and a head of a first rear passenger 38 seated in a first rear passenger seat 40, and at least the upper torso and a head of a second rear passenger 42 seated in a second rear passenger seat 44 to be included together with the vehicle operator 26 discussed in reference to FIG. 1. A range of the viewing window 20 therefore permits facial features and recognition of each of the vehicle passengers, as well as reception of gestures made by any of the passengers to be identified by software provided within the central processing unit 30.

The gestures made by any of the passengers can be predefined gestures saved in a memory which indicate for example to increase or decrease a radio volume, to turn on or turn off a feature such as a ventilation system fan, or the like. The gestures are there repeatable and either pre-programmed into the memory or learned on a case-by-case basis. The computer of the central processing unit 30 can also be pre-programmed to recognize facial features of the operator such as eye movement which indicates drowsiness or sleep such that corrective action or operator warnings can be issued.

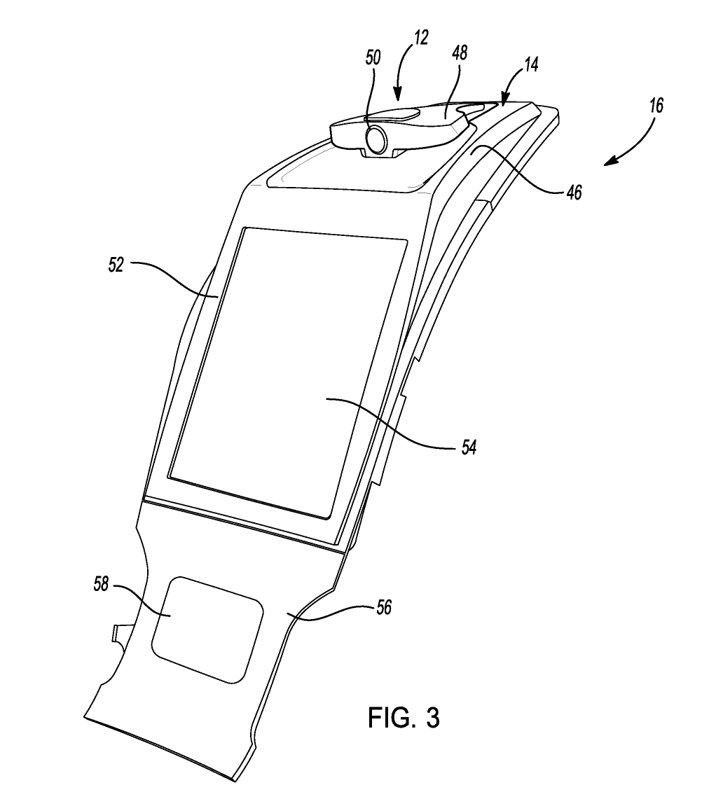

Referring to FIG. 3 and again to FIGS. 1-2, the console 16 includes an upper portion 46 which directly supports the camera unit 12. The camera unit 12 includes a camera housing 48 which incorporates a single camera 50 positioned above the upper portion 46. The console 16 further includes a center or mid-portion 52 which according to several aspects provides a display screen 54. Information such as but not limited to heating and air conditioning settings, GPS navigation system input and output, radio system controls, and telephone and email output can be presented on the display screen 54. According to further aspects, the console 16 further includes a lower-portion 56 which provides a second display screen 58 defining a touch screen or touchpad. The second display screen 58 can be used for example to input operator or passenger gestures by proximity motion or direct contact touch input to affect changes to features presented on the display screen 54, without directly contacting the display screen 54.

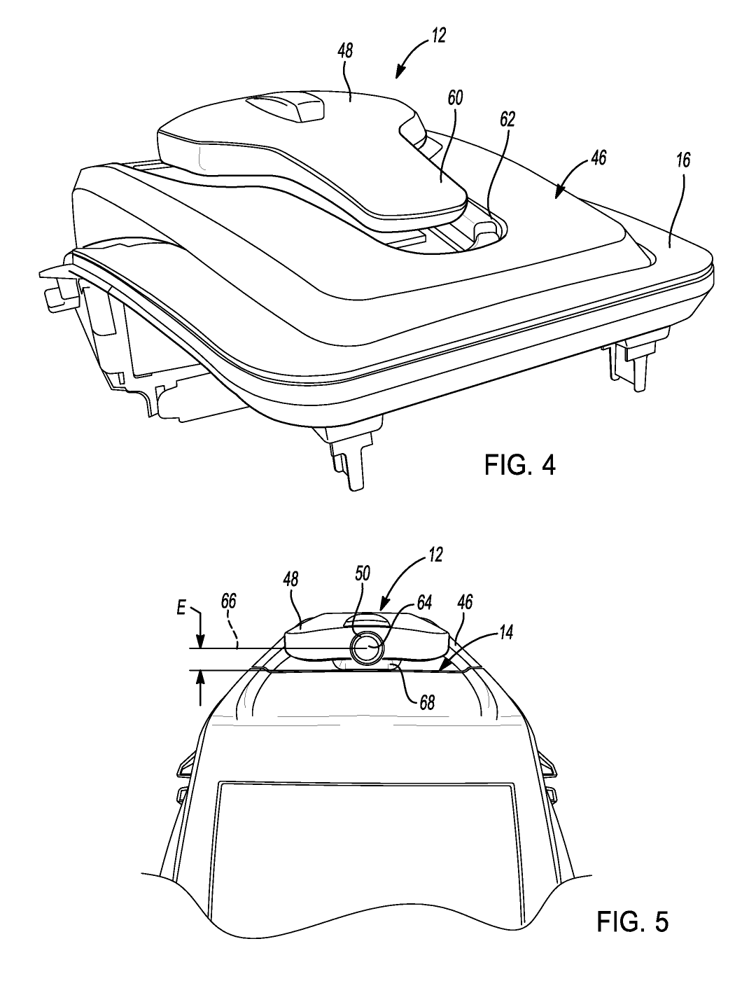

Referring to FIG. 4 and again to FIGS. 1-3, the camera unit 12 and the console 16 can each be provided as a combination of molded polymeric material, metal, and/or composite material components, where the polymeric material components can be made for example using an injection molding process to provide for a diverse geometry. The camera housing 48 includes a front facing portion 60 which is partially received and retained within a cavity 62 of the upper portion 46 of the console 16. The camera housing 48 is releasably mounted to the upper portion 46, for example using fasteners or using snap-fit joints, and can be removed for maintenance or replacement of the camera 50.

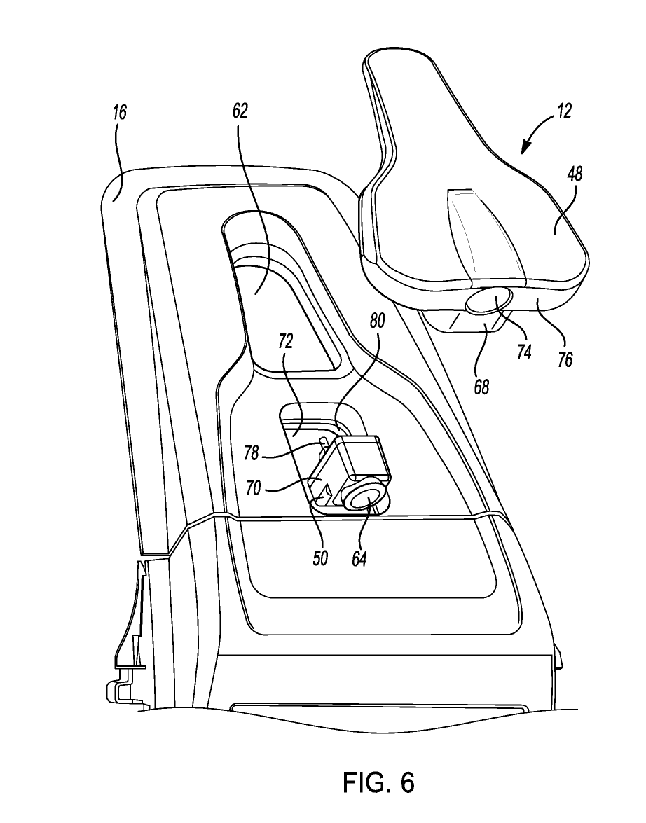

Referring to FIG. 5 and again to FIGS. 1-4, the camera 50 includes a single camera lens 64 directed or facing rearward in the motor vehicle 18 into the passenger compartment 17 and therefore toward the passengers of the motor vehicle 18. A horizontal central axis 66 of the camera lens 64 is positioned at an elevation “E” above the upper surface 14 of the vehicle console 16. A camera body enclosure 68 is integrally connected to the camera housing 48. A portion of the camera body enclosure 68 is received within the upper portion 46 with a predefined length of the camera body enclosure 68 extending outward from and above the upper portion 46 to establish the elevation “E”. The camera lens 64 is entirely elevated above the upper surface 14 of the upper portion 46 so that the upper surface 14 of the vehicle console 16 does not directly interfere with the camera lens 64. To further maximize the viewing window 20, the camera lens 64 defines a wide angle lens having an approximate 180 degree viewing area.

Referring to FIG. 6 and again to FIGS. 1-5, to provide access for electrical and signal connections to the camera 50, a camera body 70 of the camera 50 is partially received within the camera body enclosure 68. The camera body enclosure 68 is positioned within an aperture 72 located rearward of the cavity 62 of the upper portion 46 of the console 16. The camera lens 64 extends through a lens cavity 74 created in a rear facing wall 76 of the camera housing 48. The aperture 72 provides access from below the upper portion 46 of the console 16 to access a signal connector 78 of the camera 50. The aperture 72 can also include a flange 80 which the camera body enclosure 68 abuts to establish the elevation “E” shown and discussed with respect to FIG. 5.

A vehicle console camera system 10 of the present disclosure offers several advantages. These include the use of a single camera having a wide angle lens mounted to the upper surface of a motor vehicle console. The single camera replaces multiple sensors previously known for data acquisition, and is capable of viewing all of the passengers in the motor vehicle. The elevation and central axis placement of the camera maximize a viewing window of the camera. The collection of information via a single camera reduces system costs, and also reduces the need to triangulate passenger positions, and therefore reduces the chance of misinterpretation of gestures of any of the passengers.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A vehicle console camera system, including:
a console positioned in a passenger compartment of a motor vehicle;
a camera mounted to an upper surface of the console, the camera having a camera lens facing rearward; and
a viewing window of the camera capturing at least an upper torso and a head of an operator of the motor vehicle.

2. The vehicle console camera system of claim 1, wherein the camera is incorporated into a camera unit, and wherein the console includes an upper portion which directly supports the camera unit.

3. The vehicle console camera system of claim 2, wherein the camera unit includes a camera housing incorporating the camera positioned above the upper portion.

4. The vehicle console camera system of claim 3, wherein the camera housing includes a motor vehicle front facing portion which is partially received and retained within a cavity of the upper portion of the console.

5. The vehicle console camera system of claim 3, wherein a camera body enclosure is integrally connected to the camera housing having a portion of the camera body enclosure received within the upper portion with a predefined length of the camera body enclosure extending outward from and above the upper portion.

6. The vehicle console camera system of claim 2, wherein a horizontal central axis of the camera lens is positioned at an elevation above the upper surface of the vehicle console, and wherein the camera lens is elevated above the upper surface of the upper portion.

7. The vehicle console camera system of claim 1, wherein the console is substantially centrally positioned in a dashboard of the motor vehicle.

8. The vehicle console camera system of claim 1, wherein the camera is positioned on a longitudinal central axis of the motor vehicle.

9. The vehicle console camera system of claim 1, wherein the viewing window further captures at least a front passenger of the motor vehicle.

10. The vehicle console camera system of claim 1, wherein the viewing window further captures at least one rear passenger of the motor vehicle.

11. The vehicle console camera system of claim 1, wherein an electrical output of the camera is communicated to a central processing unit.

12. The vehicle console camera system of claim 1, wherein an output of the camera defines a digital signal.

13. The vehicle console camera system of claim 1, wherein the camera is located at a minimum height above a floor of the motor vehicle permitting the viewing window to further include a front passenger and at least one rear seat passenger of the motor vehicle.

14. The vehicle console camera system of claim 1, wherein a range of the viewing window permits facial features and recognition of each of multiple motor vehicle passengers, as well as reception of gestures made by any of the motor vehicle passengers to be identified by software provided within a central processing unit.

15. A vehicle console camera system, including:
a console positioned in a dashboard of a motor vehicle;
a camera unit mounted to a surface of an upper portion of the console, the camera unit including a camera having a camera lens facing rearward; and
a viewing window of the camera capturing images of each of an operator and a front seat passenger of the motor vehicle;
wherein a range of the viewing window permits facial features and recognition of the operator and the front seat passenger to be identified by software provided within a central processing unit.

16. The vehicle console camera system of claim 15, wherein the camera unit is positioned on a longitudinal central axis of the motor vehicle and at a minimum height above a floor of the motor vehicle predetermined to maximize the range of the viewing window.

17. The vehicle console camera system of claim 15, wherein the range of the viewing window further permits reception of gestures made by the operator and the front seat passenger.

18. The vehicle console camera system of claim 15, wherein the camera lens defines a wide angle lens having an approximate 180 degree viewing area.

19. The vehicle console camera system of claim 15, wherein:
a camera body of the camera is partially received within a camera body enclosure of the camera unit;
the camera body enclosure is positioned within an aperture of the upper portion of the console; and
the aperture of the upper portion provides access from below the upper portion to access a signal connector of the camera.

20. A vehicle console camera system, comprising:
a console positioned in a dashboard of a passenger compartment of a motor vehicle;
a camera unit mounted to an upper portion of the console and positioned on a longitudinal central axis of the motor vehicle, the camera unit including:
a single digital camera having a wide angle camera lens facing rearward into the passenger compartment;
a camera housing having a motor vehicle front facing portion partially received and retained within a cavity of the upper portion of the console; and
a camera body enclosure integrally connected to the camera housing, the camera positioned within the camera body enclosure having the camera lens extending through a lens cavity created in a rear facing wall of the camera housing; and
a viewing window of the camera capturing images of each of an operator and a front seat passenger of the motor vehicle, wherein a range of the viewing window permits facial features and recognition of the operator and the front seat passenger, as well as reception of gestures made by the operator and the front seat passenger to be identified by software provided within a central processing unit.
